(19) United States
(12) Patent Application Publication
(10) Pub. No.: US 2017/0193435 A1
(43) Pub. Date: Jul. 6, 2017

(54) SYSTEMS AND METHODS FOR FORECASTING ON-SHELF PRODUCT AVAILABILITY

(71) Applicant: Wal-Mart Stores, Inc., Bentonville, AR (US)

(72) Inventors: Madhur Sarin, Gurgaon (IN); Nanda K. Rajanala, Hyderabad (IN); Syed M. Mudassir, Williams Town Extension (IN)

(21) Appl. No.: 15/384,722

(22) Filed: Dec. 20, 2016

Related U.S. Application Data
(60) Provisional application No. 62/293,644, filed on Feb. 10, 2016.

(30) Foreign Application Priority Data
Dec. 30, 2015 (IN) 7065/CHE/2015

(51) Int. Cl. G06Q 10/08; G06Q 30/02

(52) U.S. Cl. CPC G06Q 10/087; G06Q 30/0202

(57) ABSTRACT

In some embodiments, methods and systems of forecasting on-shelf availability of products at a retail sales facility for a selected interval of time are described. One or more on-shelf prediction factors associated with the products and/or shelf space at the retail sales facility may be processed by an electronic inventory management device to estimate whether a product is present or not present at a selected time interval on the shelf on the sales floor of the retail sales facility.

### CROSS-REFERENCE TO RELATED APPLICATIONS

This application claims the benefit of U.S. Provisional Application No. 62/293,644, filed Feb. 10, 2016, and relates to Indian Application No. 7065/CHE/2015, filed Dec. 30, 2015, which applications are incorporated by reference herein in their entireties.

### TECHNICAL FIELD

This disclosure relates generally to managing products at a retail sales facility and, in particular, to systems and methods for forecasting on-shelf availability of products on a sales floor of the retail sales facility.

### BACKGROUND

A sales floor of a typical retail sales facility such as a large department store may have hundreds of shelves and thousands of products on the shelves displayed to the consumers. Periodically, products are taken off the shelves and purchased by the consumers. To restock the shelves after products are purchased by the consumers, overstock products stored in the stock room of the retail sales facility are picked from their bins and worked to the shelves on the sales floor.

Retail sales facilities determine how many units of a given product are on a shelf on a sales floor by way of manually auditing the products on the shelves. Specifically, workers at the retail sales facility periodically walk the aisles on the sales floor and use hand-held scanners to scan the products stocked on the shelf to take inventory of the products. Given the large number of shelves at a typical retail sales facility and the large number of products on the shelves, such manual auditing of the products on the shelves is very time consuming and less effective for the workers at the retail sales facility and increases the costs of operation for the retail sales facility.

### BRIEF DESCRIPTION OF THE DRAWINGS

Disclosed herein are embodiments of systems, devices, and methods pertaining to methods and systems for estimating whether a product is present or not present on a shelf on a sales floor of a retail sales facility at a given time interval. This description includes drawings, wherein:

FIG. 1 is a diagram of a system of estimating whether a product is present or not present on a shelf on a sales floor of a retail sales facility in accordance with some embodiments.

FIG. 2 is a functional block diagram of an electronic inventory management device in accordance with some embodiments.

FIG. 3 is a flow diagram of a process of estimating whether a product is present or not present on a shelf on the sales floor of a retail sales facility at a given time interval in accordance with some embodiments.

FIG. 4 is a diagram of a system of estimating whether a product is present or not present on a shelf on the sales floor of a retail sales facility in accordance with some embodiments.

Elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. Certain actions and/or steps may be described or depicted in a particular order of occurrence while those skilled in the art will understand that such specificity with respect to sequence is not actually required. The terms and expressions used herein have the ordinary technical meaning as is accorded to such terms and expressions by persons skilled in the technical field as set forth above except where different specific meanings have otherwise been set forth herein.

### DETAILED DESCRIPTION

The following description is not to be taken in a limiting sense, but is made merely for the purpose of describing the general principles of exemplary embodiments. Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Generally, this application describes systems and methods of forecasting on-shelf availability of products at a retail sales facility, and more specifically, forecasting whether a product is present or not present at a selected time on the shelf on the sales floor of a retail sales facility by processing one or more on-shelf prediction factors associated with the product.

In one embodiment, a system of forecasting on-shelf availability of at least one product at a retail sales facility includes an electronic inventory management electronic device including a processor-based control unit configured to obtain electronic data including at least one on-shelf prediction factor associated with the at least one product. The at least one on-shelf prediction factor comprises at least one of: on-shelf probability state of the at least one product at the retail sales facility, conditional probability of sale of the at least one product at the retail sales facility during the selected time interval, root mean square error for cumulative sales of the at least one product at the retail sales facility. The control unit is further configured to estimate, based on that at least one on-shelf prediction factor, whether the at least one product is present or not present on a shelf on a sales floor of the retail sales facility at a selected interval of time on a given day, and to output, based on the estimation, a signal including electronic data indicating whether the at least one product is present or not present on the shelf on the sales floor of the retail sales facility at the selected interval of time on the given day.

In another embodiment, a method of forecasting on-shelf inventory of products at a retail sales facility includes: obtaining, by an electronic inventory management device, electronic data including at least one on-shelf prediction factor associated with the at least one product, the at least one on-shelf prediction factor comprising at least one of: an on-shelf probability state of the at least one product at the retail sales facility, a conditional probability of sale of the at least one product at the retail sales facility during the selected time interval, and a root mean square error for cumulative sales of the at least one product at the retail sales facility; estimating, by a processor-based control unit of the electronic inventory management device and based on the at least one on-shelf prediction factor, whether the at least one product is present or not present on a shelf on a sales floor of the retail sales facility at a selected interval of time on a given day; and outputting, by the electronic inventory management device and based on the estimating step, a signal including electronic data indicating whether the at least one product is estimated to be present or not present on a shelf on a sales floor of the retail sales facility at a selected interval of time on a given day.

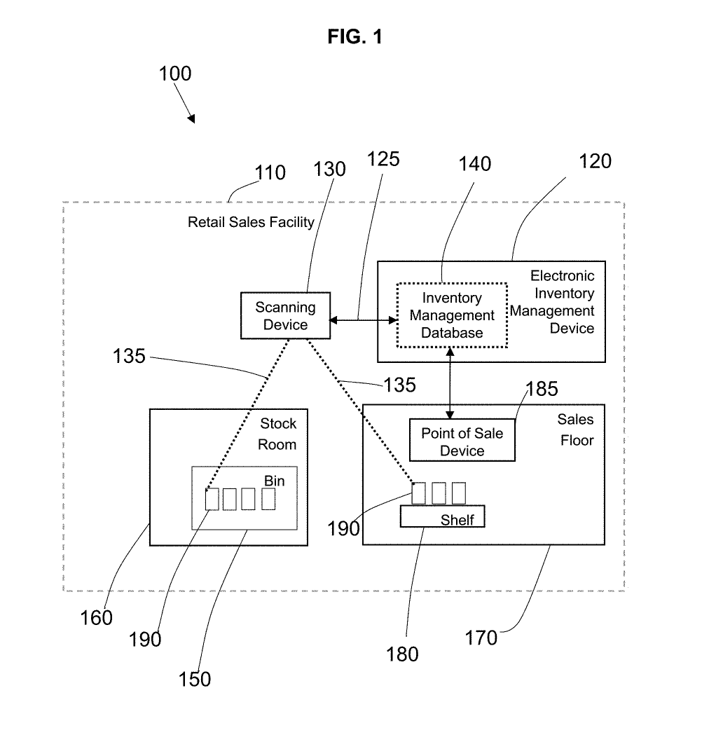

FIG. 1 shows an embodiment of one exemplary system 100 for forecasting availability of products 190 on shelves 180 on a sales floor 170 of a retail sales facility 110. The retail sales facility 110 may be any place of business (e.g., a brick-and-mortar store) where products 190 are stocked and offered for sale to consumers. While the sales floor 170 of the retail sales facility 110 is illustrated in FIG. 1 as having one shelf 180 having three products 190 for ease of illustration, it will be appreciated that the sales floor 170 may have hundreds or thousands of shelves 180 and that each shelf 180 may contain dozens or hundreds of products 190.

The system 100 depicted in FIG. 1 includes an electronic inventory management device 120 configured generally to manage the inventory of products 190 at the retail sales facility 110, and more specifically, to manage electronic data associated with the products 190 in inventory at the retail sales facility 110. The electronic inventory management device 120 in FIG. 1 may be a stationary or portable electronic device including a processor-based control unit, for example, a desktop computer, a laptop computer, a tablet, a mobile phone, or any other electronic device configured for data entry and one-way and/or two-way communication with another device located at the retail sales facility 110 (e.g., scanning device 130).

It will be appreciated that the electronic inventory management device 120 may be configured for wired or wireless communication with one or more electronic devices (e.g., database server, regional server, or the like) located at or remote to the retail sales facility 110 and configured for two-way communication with the electronic inventory management device 120. It will also be appreciated that the electronic inventory management device 120 may be itself located remote to the retail sales facility 110 and configured for communication with one or more stationary or portable electronic devices local to the retail sales facility 110.

With reference to FIG. 1, the exemplary electronic inventory management device 120 includes an inventory management database 140 configured to store electronic data associated with the products 190 at the retail sales facility 110. Such data may include data associated with the products 190 stored in bins 150 in a stock room 160 of the retail sales facility 110, products 190 stocked on shelves 180 on the sales floor 170 of the retail sales facility 110, and/or products 190 sold at point-of-sale device 185 (e.g., sale registers) at the retail sales facility 110, as well as the tasks performed by workers with respect to the products 190. In some embodiments, the inventory management database 140 may store electronic data including but not limited to: real-time inventory information associated with the products 190 at the retail sales facility 110, historical sales information associated with the products 190 at the retail sales facility 110, and on-shelf estimation data associated with the products 190 at the retail sales facility 110.

The electronic data representing the real-time inventory information stored in the inventory management database 140 may include historical data derived from transaction data (e.g., sales) and worker task data (e.g., delivery, binning, and/or picking) associated with the products 190, as well as data indicating total number of products 190 in inventory and maximum shelf space for the products 190 at the retail sales facility 110. For example, the real time inventory data may include a total number of products 190 available in the retail sales facility 110 at a given time or historically over a period of one or more days or one or more weeks. The historical sales information stored in the inventory management database 140 may include the total number of products 190 sold at the retail sales facility 110 historically over a period of one or more intervals during a day, one or more days, or one or more weeks. The on-shelf estimation data stored in the inventory management database 140 may include data generated based on physical audits of shelves 180 at the retail sales facility 110 containing the products 190 for which an estimation of whether or not the products 190 are present on the shelf 180 were made by the electronic inventory management device 120.

In some embodiments, the inventory management database 140 may store electronic data in the form of on-shelf prediction factors. As discussed in more detail below, the on-shelf prediction factors are factored in by the processor of the electronic inventory management device 120 in estimating whether a product 190 is present or not present on a shelf 180 on the sales floor 170 of the retail sales facility 110 at a given time. Such on-shelf prediction factors will be discussed in more detail below and include, but are not limited to: on-shelf probability state of a product 190 at the retail sales facility 110; conditional probability of sale of the product 190 at the retail sales facility 110 during a selected time interval; root mean square error for cumulative sales of the product 190 at the retail sales facility 110; probability of sale of the product 190 at the retail sales facility 110 based on at least one interval of time equal to the selected interval of time but on at least one day prior to the given day; a consumer demand for the product 190 at the retail sales facility 110 during a predetermined time interval; average sales of the product 190 at the retail sales facility 110 during the predetermined time interval; average sales of the product 190 at the retail sales facility 110 based on a day of the week; a percentage of sales attributed to sales of the product 190 at the retail sales facility 110 within a product category associated with the product 190; format of the retail sales facility; travel time for replenishment of the product 190 at the retail sales facility 110; perpetual inventory of the product 190 at the retail sales facility 110; total sales of the product 190 at the retail sales facility 110 during at least one time interval preceding the selected interval of time on the given day; time elapsed since last sale of the product 190 at the retail sales facility 110; available space for the product 190 on the shelf 180 on the sales floor 170 of the retail sales facility 110; a type of the product 190; mod effective date; and at least one demographic variable associated with the retail sales facility 110.

The on-shelf prediction factors and other electronic data that may be stored in the inventory management database 140 in association with the products 190 at the retail sales facility 110 may be received by the electronic inventory management device 120, for example, as a result of a worker (e.g., stock room associate) scanning the products 190 using the scanning device 130, for example, during binning of the product 190 or when placing the product 190 onto a shelf 180. In some embodiments, at least some of the electronic data representing one or more of the on-shelf prediction factors may be transmitted to the electronic inventory management device 120 from the point-of-sale device 185 (e.g., sale register) local to the retail sales facility 110 or from one or more databases remote to the retail sales facility 110.

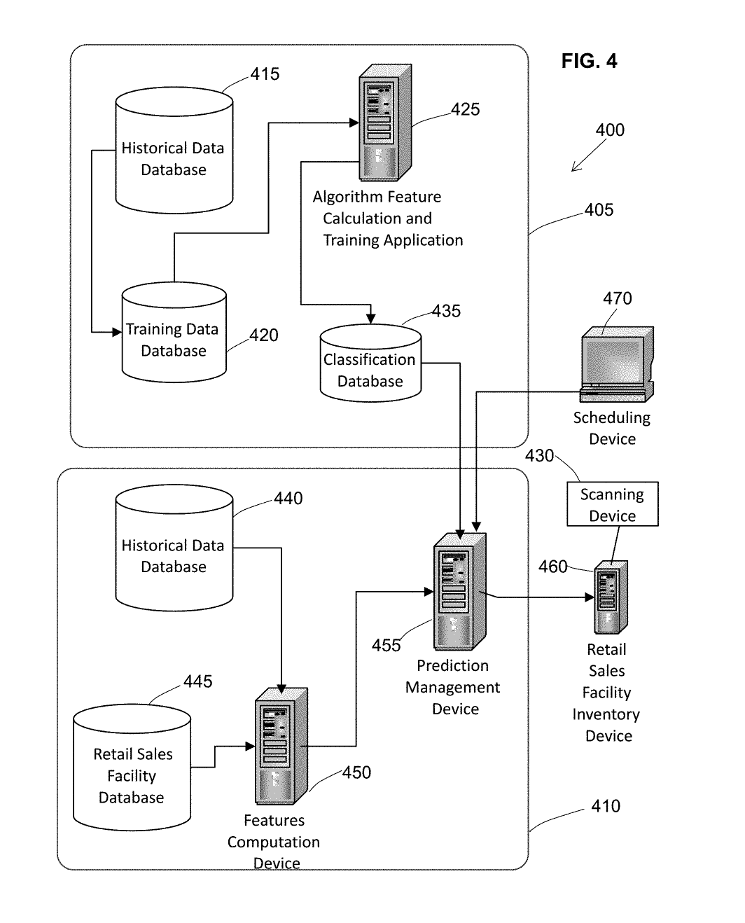

It will be appreciated that the inventory management database 140 does not have to be incorporated into the electronic inventory management device 120 as shown in FIG. 1, but may be stored on one or more devices separate from the electronic inventory management device 120 and local to the retail sales facility, or on one or more servers remote to the retail sales facility 110 and in communication with the electronic inventory management device 120. It will also be appreciated that while the inventory management database 140 is illustrated as a single database in FIG. 1, the inventory management database 140 may include two, three, four or more databases each storing different types of data associated with the products 190 at the retail sales facility 110. In addition, it will be appreciated that while the electronic inventory management device 120 is illustrated as a single device in FIG. 1, the electronic inventory management device 120 may include two, three, four or more devices (each coupled to, or including one or more databases) in communication with one another. An exemplary system 400 including multiple electronic inventory management devices and multiple databases is illustrated in FIG. 4.

In some embodiments, the scanning device 130 of FIG. 1 may be an electronic (e.g., hand-held) scanner that may be carried by a worker at the retail sales facility 110. Examples of such scanning devices 130 may include, but are not limited to barcode readers, RFID readers, SKU readers, electronic tablets, cellular phones, or the like mobile electronic devices. Alternatively, the scanning device 130 may be a stationary electronic scanning device installed in the stock room 160 or on the sales floor 170 of the retail sales facility 110. In the exemplary embodiment illustrated in FIG. 1, the scanning device 130 may obtain electronic data associated with the products 190 in a bin 150 in the stock room 160 or on a shelf 180 on the sales floor 170 by communicating via a communication channel 135 (e.g., radio waves) with a unique identifying indicia (e.g., barcode, RFID (radio frequency identification), or SKU (stock keeping unit number)) on an exterior of the products 190 or on an exterior of the bins 150.

After a product 190 is scanned via the scanning device 130 as described above, the electronic inventory management device 120 may receive electronic data associated with the product 190 (e.g., data uniquely identifying the product 190) from the scanning device 130 by way of a two-way communication channel 125, which may be a wired or wireless (e.g., Wi-Fi) connection. For example, when a worker places a product 190 onto a shelf 180 on the sales floor 170 of the retail sales facility 110, the worker may use the scanning device 130 to scan the unique identifier of the product 190, in response to which the data uniquely identifying the product 190 is obtained by the scanning device 130. In addition, as the worker places the product 190 into the shelf 180 on the sales floor 170, data identifying the task performed by the worker with respect to the product 190 (i.e., restocking) may be entered into the system 100 via the scanning device 130.

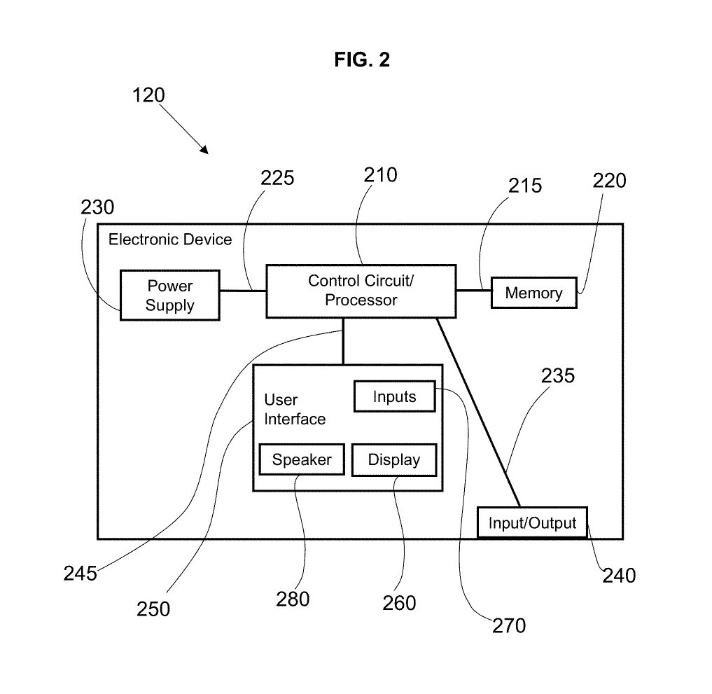

An exemplary electronic inventory management device 120 depicted in FIG. 2 is a computer-based device and includes a control circuit (i.e., control unit) 210 including a processor (for example, a microprocessor or a microcontroller) electrically coupled via a connection 215 to a memory 220 and via a connection 225 to a power supply 230. The control unit 210 can comprise a fixed-purpose hard-wired platform or can comprise a partially or wholly programmable platform, such as a microcontroller, an application specification integrated circuit, a field programmable gate array, and so on. These architectural options are well known and understood in the art and require no further description here.

This control unit 210 can be configured (for example, by using corresponding programming stored in the memory 220 as will be well understood by those skilled in the art) to carry out one or more of the steps, actions, and/or functions described herein. In some embodiments, the memory 220 may be integral to the processor-based control unit 210 or can be physically discrete (in whole or in part) from the control unit (i.e., control unit) 210 and is configured non-transitorily store the computer instructions that, when executed by the control unit 210, cause the control unit 210 to behave as described herein. (As used herein, this reference to “non-transitorily” will be understood to refer to a non-ephemeral state for the stored contents (and hence excludes when the stored contents merely constitute signals or waves) rather than volatility of the storage media itself and hence includes both non-volatile memory (such as read-only memory (ROM)) as well as volatile memory (such as an erasable programmable read-only memory (EPROM))).

Accordingly, the memory 220 and/or the control unit 210 may be referred to as a non-transitory medium or non-transitory computer readable medium. The control unit 210 of the electronic inventory management device 120 is also electrically coupled via a connection 235 to an input/output 240 that can receive signals from and send (via a wired or wireless connection) signals (e.g., commands, inventory database information) to devices (e.g., scanning device 130) local to the retail sales facility 110, or one or more devices remote to the retail sales facility 110.

Optionally, instead of receiving information regarding the products 190 in the bins 150 from a separate scanner such as the scanning device 130, the control unit 210 may incorporate or be electrically coupled to a sensor such as a reader configured to detect and/or read information on the identifying indicia (e.g., a label) located on the products 190 and/or on the bin 150 when the electronic inventory management device 120 is placed in direct proximity to the product 190 and/or the bin 150. Such an optional reader may be a radio frequency identification (RFID) reader, an optical reader, a barcode reader, or the like.

In the embodiment shown in FIG. 2, the processor-based control unit 210 of the electronic inventory management device 120 is electrically coupled via a connection 245 to a user interface 250, which may include a visual display or display screen 260 (e.g., LED screen) and/or button input 270 that provide the user interface 250 with the ability to permit a user such as a stock room or sales floor associate at the retail sales facility 110 to manually control the electronic inventory management device 120 by inputting commands, for example, via touch-screen and/or button operation or voice commands. The display screen 260 can also permit the user to see various menus, options, worker tasks, and/or alerts displayed by the electronic inventory management device 120. The user interface 250 of the electronic inventory management device 120 may also include a speaker 280 that may provide audible feedback (e.g., alerts) to the user.

With reference to FIGS. 1-3, one method 300 of operation of the system 100 for forecasting on-shelf availability of products 190 at a retail sales facility 110 will now be described. For exemplary purposes, the method 300 is described in the context of the system of FIG. 1, but it is understood that embodiments of the method 300 may be implemented in the system 100 or other systems.

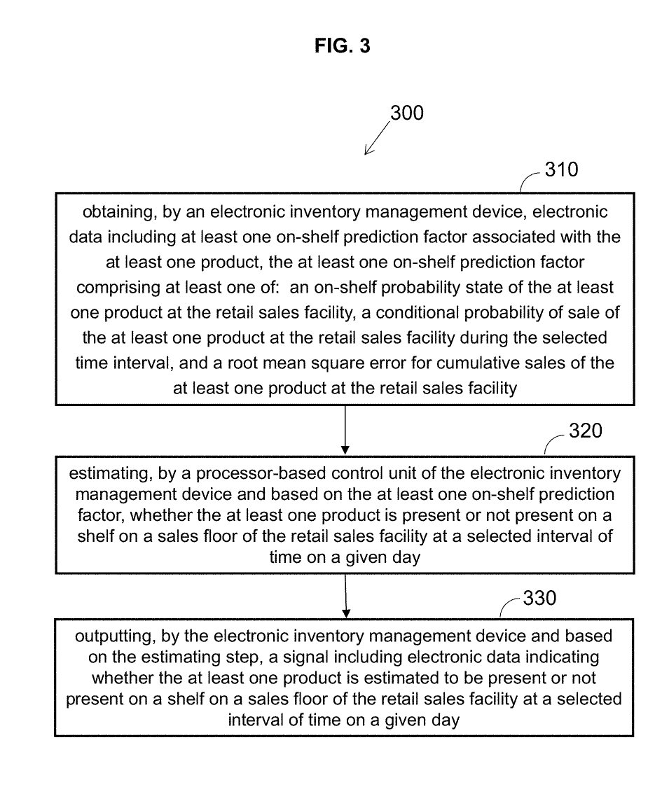

The exemplary method 300 shown in FIG. 3 includes obtaining, by the electronic inventory management device 120, electronic data including at least one on-shelf prediction factor associated with one or more products 190 at the retail sales facility 110 (step 310). In some embodiments, one or more of the above-discussed on-shelf prediction factors associated with a product 190 may be obtained by the electronic inventory management device 120 as a result of the control unit 210 sending a signal including a request for the on-shelf prediction factor(s) associated with the product 190 to be retrieved from the inventory management database 140 and/or another inventory management database. Responsive to such a request, one or more on-shelf prediction factors may be transmitted to the electronic inventory management device 120 from the inventory management database 140 or from a database remote to the retail sales facility 110.

In the embodiment illustrated in FIG. 3, the on-shelf prediction factors associated with a product 190 at the retail sales facility 110 that may be processed by the control unit 210 to determine whether the product 190 is present or not present on the shelf 180 on the sales floor 170 of the retail sales facility 110 include, but are not limited to: on-shelf probability state of the product 190 at the retail sales facility 110, a conditional probability of sale of the product 190 at the retail sales facility 110 during a selected time interval, and a root mean square error for cumulative sales of the product 190 at the retail sales facility 110. It will be appreciated that the on-shelf prediction factors in FIG. 3 are shown by way of example only, and that both additional and alternative on-shelf prediction factors may be processed by the control unit 210 of the electronic inventory management device 120 to determine whether the product 190 is present or not on the shelf 180 on the sales floor 170 of the retail sales facility 110. In addition, it will be appreciated that the estimation by the control unit 210 of whether the product 190 is present or not present on the shelf 180 on the sales floor 170 of the retail sales facility 110 may be made based on the processing of only one, only two, or all three of the on-shelf prediction factor in FIG. 3, or based on processing four or more on-shelf prediction factors.

Some other exemplary on-shelf prediction factors that may be processed by the control unit 210 of the electronic inventory management device 120 to determine whether the product 190 is present or not on the shelf 180 on the sales floor 170 of the retail sales facility 110 include but are not limited to on-shelf probability state of a product 190 at the retail sales facility 110; conditional probability of sale of the product 190 at the retail sales facility 110 during a selected time interval; root mean square error for cumulative sales of the product 190 at the retail sales facility 110; probability of sale of the product 190 at the retail sales facility 110 based on at least one interval of time equal to the selected interval of time but on at least one day prior to the given day; a consumer demand for the product 190 at the retail sales facility 110 during a predetermined time interval; average sales of the product 190 at the retail sales facility 110 during the predetermined time interval; average sales of the product 190 at the retail sales facility 110 based on a day of the week; a percentage of sales attributed to sales of the product 190 at the retail sales facility 110 within a product category associated with the product 190; format of the retail sales facility; travel time for replenishment of the product 190 at the retail sales facility 110; perpetual inventory of the product 190 at the retail sales facility 110; total sales of the product 190 at the retail sales facility 110 during at least one time interval preceding the selected interval of time on the given day; time elapsed since last sale of the product 190 at the retail sales facility 110; available space for the product 190 on the shelf 180 on the sales floor 170 of the retail sales facility 110; a type of the product 190; mod effective date; and at least one demographic variable associated with the retail sales facility 110. Some of the above-listed on-shelf prediction factors are discussed in more detail below.

In the exemplary method 300 illustrated in FIG. 3, the control unit 210 of the electronic inventory management device 120 is programmed to estimate, based on at least one of the on-shelf prediction factors associated with the product 190, whether the product 190 is present or not present on a shelf on a sales floor of the retail sales facility 110 at a selected interval of time on a given day (step 320). Some exemplary calculations and equations facilitating this estimation according to some embodiments are discussed below.

The “on-shelf probability state” on-shelf prediction factor for a product 190 reflects a probability of a given number of products 190 being on the shelf 180 at a given time, with the number of the products 190 on the shelf 180 being less than the maximum shelf space for the product 190 at the retail sales facility 110. In some embodiments, the control unit 210 of the electronic inventory management device 120 is programmed to assume that no product 190 can have more units on the shelf 180 than the allocated maximum capacity of the product 190 on the shelf 180 at any time of the day. The ‘state’ of the product 190 on the shelf 180 based on such an assumption can vary between 0 units to full shelf (i.e., maximum shelf capacity). The on-shelf probability state on shelf prediction factor (X1) at a given time t may be defined as shown below:

$${X 1}_{t} = \frac{1}{1 + Max k - {{\sum }_{t = 0}^{t} {S}_{t}}_{ } }$$

where Max k=shelf capacity and S is sale in time interval t

In some embodiments, the control unit 210 of the electronic inventory management device 120 is programmed to assign a probability to each of the on-shelf states of the product 190 based on sales of the products 190 at the retail sales facility 110. For example if the maximum shelf capacity of a product 190 is three units (as shown in FIG. 1) and the inventory of the product 190 available at the retail sales facility 110 is greater than three units (e.g., four units of the product 190 are stored in a bin 150 in the stock room 160), then at any given point of time in the day, there can be only four possible states of the shelf 180 on which the product 190 is displayed. In other words, there could be either 3, or 2, or 1, or 0 products 190 on the shelf 180 at any given time of the day. Since the restocking activity of the products 190 by workers at the retail sales facility 110 is often random and not based on a fixed restocking schedule, the starting on shelf probability state factor (X1) value (assuming 12:00 am as the start time) in the above example becomes 0.25, indicating a 25% probability at any given time that the shelf 180 will exist in any one of the above-discussed four possible states.

In some embodiments, the control unit 210 of the electronic inventory management device 120 is programmed to track sales of a product 190 at the retail sales facility 110 at every 15 minute interval, and to recalculate the change in the on-shelf probability state relative to the starting on-shelf probability at every 15 minute interval. If electronic data indicating a sale of one of the three products 190 is received by the electronic inventory management device 120 at 12:15 am following a 12:00 am start of the 15 minute interval, the control unit 210 of the electronic inventory management device 120 may be programmed to recalculate the on-shelf state probability from its initial value of 0.25 to a modified value of 0.33 (assuming no re stocking has taken place in the last interval), since only 3 possible states of the product 190 on the shelf 180 remain, since there would be either 2 or 1 or 0 products 190 on the shelf 180 at any given time following the sale of one of the three products 190 initially present on the shelf 180 assuming no restocking of the product 190 happened in the interval between 12:00 am to 12:15 am.

In some embodiments, the control unit 210 is programmed to interpret a value of the on-shelf probability state factor (X1ₜ) being greater than 1 or less than 0 as an indication that a restocking of the product 190 on the shelf 180 has been carried out by a worker at the retail sales facility 110. The value of the probability state factor (X1ₜ) is then reset to initial value calculated for the start of the day. The control unit 210 may also be programmed to interpret a higher values, closer to 1 but not greater than 1 or <0 of the calculated on-shelf state probability as an indication of a higher likelihood that the product 190 (which starts with a full shelf 180 at the start of the day) is not present on the shelf 180 for a product 190. Since it may be difficult to define a start of the day time for a retail sales facility 110 that operates 24 hours a day, in some embodiments, the control unit 210 of the electronic inventory management device 120 may be programmed to interpret the start of day time as the time when the product 190 is at maximum capacity on the shelf 180 on the sales floor 170 of the retail sales facility 110. It will be appreciated that since not all products 190 may be at full shelf capacity at the start of the day, and given that on-shelf state probabilities for products 190 having no consumer demand may peak at a certain value and not change, the control unit 210 may be programmed to evaluate one or more on-shelf prediction factors in addition to the on-shelf probability state factor in order to more accurately estimate whether the product 190 is present or not present on the shelf 180 at any given time throughout the day.

The “conditional probability of sale in an interval” on-shelf prediction factor for a product 190 refers to a probability of occurrence of a sale of the product 190 in a given interval of time given the known number of sales of the product 190 during the preceding identical interval. For example, based on this factor, the control unit 210 of the electronic inventory management device 120 may be programmed to interpret that a product 190 with a known forecasted demand of F for the given day so far is expected to have a sales volume approximately equal to based on historical demand during any 15 minute intervals during the given day. In some embodiments, the control unit 210 of the electronic inventory management device 120 may be programmed to define the conditional probability of sale factor (X3) as:

$${X3}_{t} = \frac{F - {\sum }_{t = 0}^{t = n} S}{96 - {\sum n}^{ } }$$

where n=1 when Sₜ=0 & F is daily sales volume forecast

For example, the control unit 210 may be programmed to divide an entire day (i.e., 24 hour interval) into 96 intervals of 15 minute each, with the day starting at 12:00 am. Then, since the products 190 at the retail sales facility 110 undergo a finite number of unit sales at the point-of-sale device 185 in a given day (and during a given 15 minute interval of the day), and since each sale of the product 190 is transmitted from the point-of-sale device 185 to the electronic inventory management device 120 and recorded in the inventory management database 140, the control unit 210 can calculate the total number of sales of the product 190 throughout a given day for estimating daily forecast F and during any of the 96 15-minute intervals of the day for estimating cumulative volume sales till the start of any given interval of time, for which ‘Conditional probability of Sale in an interval’ on shelf prediction factor is to be calculated. Then based on the known total number of sales of the product 190 during the preceding 15-minute interval and the daily forecast, forecast of the sales for the next 15-minute interval of the day is estimated.

As seen above, a forecast by the control unit 210 based on the conditional probability of sale in time interval on-shelf prediction factor provides an approximation of the number of sales of a product 190 that can be expected across an interval of interest across a given day. As such, based on an assumption that each interval of time throughout the day has an equal probability of getting a sale of the product 190, the control unit 210 can estimate the probability of sale of the product 190 at a given interval knowing how many unit sales of the product 190 occurred in the preceding identical interval of time and the daily forecast based on historical demand. In some embodiments, the control unit 210 is programmed to interpret a high value of the conditional probability factor as an indication of an increased likelihood that the product 190 is not present on the shelf 180.

It will be appreciated that generally, not all intervals of the day have an equal probability of a sale of the product 190 taking place, since the arrival of customers at a retail sales facility 110 is not uniform throughout the day. Accordingly, some intervals of time throughout the day are likely to have a higher probability of sale than other intervals based on customer arrival distribution. As such, the control unit 210 of the electronic inventory management device 120 may be programmed to evaluate one or more on-shelf prediction factors in addition to the conditional probability of sale in a time interval factor in order to more accurately estimate whether the product 190 is present or not present on the shelf 180 at any given time throughout the day.

The “root mean square error for cumulative sales” on-shelf prediction factor refers to a variation in cumulative sales over an average cumulative sale is computed for every 15 minute interval of a day over an interval of one or more consecutive days (e.g., 7 days, 14 days, 30 days, 60 days, etc.). In other words, the root mean square error for cumulative sales on-shelf prediction factor is premised on an assumption that the average volume of sales of the product 190 over a selected daily time interval (e.g., 11:00 am to 11:15 am or 7:30 pm to 7:45 pm) during a selected period of days/weeks (1 week, 2 weeks, 4 weeks, 6 weeks, 8 weeks, etc.) indirectly indicates the possibility of sale of that product 190 occurring during the same time interval of the day (i.e., 11:00 am to 11:15 am or 7:30 pm to 7:45 pm) on the day for which the forecast is being made. In some embodiments, the control unit 210 of the electronic inventory management device 120 may be programmed to define the root mean square error for cumulative sales (X11) on-shelf prediction factor as:

X11={square root over ((Σsₜ^{avg}−Σsₜ²)}

In some embodiments, the control unit 210 is programmed to determine the value representing an average number of unit sales of the product 190 during a given historical period (e.g., 8 weeks) by retrieving historical data relating to sales of the product 190 from the inventory management database 140. This determination by the control unit 210 is generally based on an assumption that for an average day, the number of units of product 190 sold during any interval is close to the historical average of sales for that product 190 during that interval of the day. Generally, products 190 having a high sales volume stay closer to this assumption in each interval, while slow-moving products 190 are further away from this assumption due to sales variations. Nonetheless, all products 190 are subject to fluctuation in the daily number of sales throughout a week (e.g., Monday vs. Sunday or regular day vs. holiday). Accordingly, some days throughout the week are likely to have a higher probability of sale of the product 190 during a specific time interval than other days during that same time interval based on customer arrival distribution. As such, the control unit 210 of the electronic inventory management device 120 may be programmed to evaluate one or more on-shelf prediction factors in addition to the root mean square error for cumulative sales on-shelf prediction factor in order to more accurately estimate whether the product 190 is present or not present on the shelf 180 at a given time interval of the day.

The “probability of sale” on-shelf prediction factor refers to the probability of sale of a product 190 during any 15 minute interval over a selected period of days or weeks (e.g., 8 week or 10 week average). In some embodiments, when estimating whether a product 190 is present or not on the shelf 180 based on the probability of sale on-shelf prediction factor, the control unit 210 of the electronic inventory management device 120 is programmed to obtain a historical value of sales of the product 190 in any given 15 minute interval of the day during the preceding 8 weeks and to evaluate each 15-minute interval independently of other 15-minute intervals in a day based on 8 week history sales for a given 15 minutes interval. As such, if the control unit 210 of the electronic inventory management device 120 retrieves (e.g., from the inventory management database 140) historical data indicating, for example, that 0.75 is the probability of sale of the product 190 during a 15-minute time interval based on the volume sale recorded for that interval in the last 8 weeks preceding the day for which the forecast is being made, the control unit 210 is programmed to assume that the probability of making a sale of at least 1 unit of product 190 during the forecasted 15 minute interval on the given day should be close to 3 out of 4 instances based on 8 weeks history In an another example, if the value of probability of sale is calculated to be 1 based on preceding 8 weeks of history data for any given interval, in this scenario, the control unit 210 would forecast that the product 190 is highly likely to make a sale during the 15 minutes interval for which the forecast is being made on a given day.

As discussed above, it will be appreciated that fluctuations in the sales of the product 190 at the retail sales facility 110 may occur throughout the course of a day and throughout the course of the week, based on customer arrival distribution. As such, the control unit 210 of the electronic inventory management device 120 may be programmed to evaluate one or more on-shelf prediction factors in addition to the “probability of sale” on-shelf prediction factor in order to more accurately estimate whether the product 190 is present or not present on the shelf 180 at a given time interval of the day.

The “product interval demand” on-shelf prediction factor refers to a consumer demand for a product 190 during a given interval of time. For example, in order to estimate a demand for a given interval of time (e.g., 15 minutes), in some embodiments, the control unit 210 of the electronic inventory management device 120 may be programmed to calculate/retrieve (e.g., from the inventory management database 140) a daily demand forecast for the product 190 at a level of the retail sales facility 110 and split this daily-level demand into the constituent intervals. Then, to estimate the availability or unavailability of the product 190 on the shelf 180 at the retail sales facility 110 at every 15 minute interval, the control unit 210 retrieves the known demand for the product 190 during each of these intervals and compares the interval demand with the actual number of units of the product 190 sold during the same interval.

In some embodiments, the control unit 210 of the electronic inventory management device 120 is programmed to set the daily demand as D and evaluate D as being directly proportional to the total transactions (T) in a given day. Since transactions (sales of the product 190) at the retail sales facility 110 are not constant, but continuously vary by time interval based on customer shopping patterns, the control unit 210 may be programmed to interpret the transactions associated with the product 190 as a function of time as follows:

T=f(t)

D∝g(T)∝g(f(t))

Then, the control unit 210 may be programmed to calculate the demand for the product 190 in an interval between tⁿ and t^{(n+Δn)} using the area under a curve defined by the following Equation

$${E}_{i}^{n} = \frac{K . D}{T} {\int }_{n}^{n + Δ n} f ( t ) dt \\ or , {E}_{i}^{n} = \frac{{K}_{i} . {D}_{i}}{T} {\sum }_{n}^{n + Δ n} f ( t ) \\ where {E}_{i}^{n} = Estimated Product Interval Demand at time interval {t}_{n} for an item i \\ where \frac{{D}_{i}}{T} is the Normalization constant for item i \\ where {K}_{i} = Correction factor for item i \qquad ( 1 )$$

It will be appreciated that the demand for the product 190 at each interval is a Markov process and for a short interval can be represented using Poisson distribution. It will also be appreciated that the shape of the curve defined in Equation 1 above is expected to remain the same for all types the products 190 at a given retail sales facility 110, but the amplitude of the curve would be expected to vary based on the value of demand for the product 190. In some embodiments, the control unit 210 may be programmed to introduce a correction factor K in order for Equation 1 to reflect a more accurate variation of demand for a given product 190. An exemplary derivation of the correction factor K is discussed below. The correction factor K may take into account a correction based on customer behavior and product behavior at the retail sales facility 110.

The “product interval sales velocity” on-shelf prediction factor reflects accounts for the possibility that, for a given time interval, a product 190 may sell faster or slower as compared to other products 190 in the category of the product 190, or as compared to aggregated sales of products 190 at the retail sales facility 110. In some embodiments, the control unit 210 may be programmed to process this factor to estimate the correction factor K and to categorize a product 190. Generally, the product interval sales velocity on-shelf prediction factor may account for the difference in sales velocity of a product 190 under consideration when compared to a sales velocity of all other products 190 at the retail sales facility 110, as summarized by the equations below:

$$ρ = \frac{{S}_{i avg}^{n}}{max ( {S}_{i avg} )} \times \frac{max ( {S}_{avg} )}{{S}_{avg}^{n}} \qquad ( 2 )$$

where, S_{i avg}ⁿ=Average product sale in time interval tₙ,
max(S_{i avg})=maximum sales average for a product i in a day
S_{avg}ⁿ=Average total sales (all products)in time interval tₙ,
max(S_{avg})=maximum sales average for all products in a day
where ρ=product sales interval velocity

The “product day sales index” on-shelf prediction factor accounts for the possibility that a product 190 may move faster or slower relative to its average sales in an interval value based on which day of the week it is. As discussed above, average sales for a product vary from day to day throughout the week, with sales being higher, for example on the weekend (i.e., Friday night, Saturday, and Sunday) as compared to the week days (i.e., Monday-Thursday). In some embodiments, the control unit 210 may be programmed to process this factor to estimate the correction factor K and to categorize products 190 based on sales variation introduced due to sales pattern differences on different days of the week, as summarized by the equation below.

$$μ = \frac{{[ {S}_{i avg}^{n} ]}_{day of week}}{{[ {S}_{i avg}^{n} ]}_{week}} \\ where μ = item day sales index \\ where , {[ {S}_{i avg}^{n} ]}_{week} = weekly average sales for time interval {t}_{n} for a product {i \\ [ {S}_{i avg}^{n} ]}_{day of week} = Average sales for time interval {t}_{n} for a product i for a given day e . g . Monday \qquad ( 3 )$$

The “day of the week” on-shelf prediction factor accounts for the possibility that sales volume of a given product 190 and consumer demand for the product 190 at the retail sales facility 110 may be different on different days of the week.

The “sales category contribution” on-shelf prediction factor accounts for the share represented by sales of the product 190 being forecast relative to sales of other products 190 within the product category of the product 190. Another, related on-shelf prediction factor that may be factored in by the control unit 210 of the electronic inventory management device 120 when forecasting whether a product 190 is or is not present on the shelf 180 may be “sales category contribution standard deviation.” The “sales category contribution” and the “sales category contribution standard deviation” factors may vary between different retail sales facilities 110 and between different regions.

The “store format” on-shelf prediction factor may account for differences in the format between different retail sales facilities 110 where a forecast of whether a product 190 is or is not on the shelf 180 is made. For instance, one such difference in format maybe a retail sales facility 110 that has varying hours of operation (e.g., 9 am to 9 pm, 10 am to 6 pm, etc.) on different days of the week versus a 24-hour retail sales facility 110.

Another on-shelf prediction factor that may be factored in by the control unit 210 of the electronic inventory management device 120 when forecasting whether a product 190 is or is not present on the shelf 180 may be the “replenishment distance/travel time” factor (Ø), which takes into account an approximate distance from the location where the product 190 is displayed on the sales floor 170 at the retail sales facility 110 to the location of the product in the stock room 160. The distance may be normalized by the size of the retail sales facility 110 as follows:

$$∅ = Distance \times \frac{Store Size}{Avg Store Size}$$

Another on-shelf prediction factor that may be factored in by the control unit 210 of the electronic inventory management device 120 when forecasting whether a product 190 is or is not present on the shelf 180 may be the “perpetual inventory” factor, which is based on a snap shot of available inventory of a product 190 at a given point of time or interval of time at the retail sales facility 110. For example, the perpetual inventory factor may be obtained by the control unit 210 of the electronic inventory management device by querying the inventory management database 140. In some instances, the perpetual inventory factor may be subject to inaccuracies due to loss of products 190 at the retail sales facility 110 due to damage, shrinkage (miscounting, non-delivery, theft, damages etc.).

Other on-shelf prediction factors that may be factored in by the control unit 210 of the electronic inventory management device 120 when forecasting whether a product 190 is or is not present on the shelf 180 may include: product sales standard deviation, product day sales standard deviation (c); time elapsed since last sale of the product 190; shelf space (kᵢ) for the product 190; whether the product 190 is primary or linked; product type; mod effective date; and demographic variables (e.g., location of the retail sales facility 110).

In some embodiments, the control unit 210 of the electronic inventory management device 120 may be programmed to compute the above-discussed correction factor K as follows:

K=ρ×μ (4)

In some embodiments, the control unit 210 is programmed to facilitate ease of interpretation and/or standardization of results by interpreting a result that Eᵢⁿ>kᵢ for a interval tₙ, to conclude that the shelf 180 where the product 190 is displayed needs at least 1 cycle of restocking in the time interval tₙ to tₙ₊₁. Then, for a time interval tₙ to tₙ₊₁, if the below statement is True

Sᵢⁿ≧Eᵢⁿ>kᵢ (5)

then,the control unit 210 is programmed to conclude that restocking of the shelf 180 took place in the given interval for the product and probability of unavailability of product 190 is low. Similarly, if the below statement is True

Eᵢⁿ≧kᵢ>Sᵢⁿ (6)

then the control unit 210 is programmed to conclude that the probability of unavailability of the product 190 on the shelf 180 is high.

It will be appreciated that a fast-moving product 190 may undergo multiple rounds of restocking in a given time interval, depending on the size of the time interval. For example, in a short time interval (e.g., 15 minutes), the product 190 may or may not undergo restocking, while in a 12 hour time interval, the product 190 is more likely than not to be restocked. As such, in some embodiments, the control unit 210 of the electronic inventory management device 120 may interpret the restocking of a product 190 on the shelf 180 as a binary value, and may factor in multiple restocking events, if a time larger interval (e.g., 4 hours, 6, hours, or 8 hours) is chosen.

Equation 7 below represents another possible scenario that may be processed by the control unit 210 in order to estimate the probability of whether the product 190 is unavailable on the shelf 180:

Eᵢⁿ≧Sᵢⁿ>kᵢ (7)

Equations 5, 6, and 7 above indicate that the relationship between actual sales (Sᵢⁿ), estimated demand for the product (Eᵢⁿ) and shelf space (kᵢ) significantly affects the estimation of whether a product 190 is present or not on the shelf 180 at the retail sales facility 110. The interdependence of these features may be represented using a normalized single feature called velocity ratio defined below

$$δ = \frac{{E}_{i}^{n} - {k}_{i}}{{E}_{i}^{n} - {S}_{i}^{n}} \qquad ( 8 )$$

If δ<0, this situation is equivalent to equation 5

and if δ>1, this situation is equivalent to equation 6

and if 0<δ1, this situation is equivalent to equation 7

It will be appreciated that Equations 5, 6, 7, and 8 may require modification to account for multiple restocking possibilities during a large time interval. The lower limit is then:

Limit=R*kᵢ

where R is the number of restocking required for the interval

$$R = Mod \vert \frac{{E}_{i}^{n}}{{k}_{i}} \vert - 1 \qquad ( a )$$

In addition, lost sales can be computed when the control unit 210 of the electronic inventory management device 120 correctly estimates that a product 190 is not present on the shelf 180 on the sales floor 170 of the retail sales facility 110 at a given time. The lost sales may be computed as follows:

$$Lost Sales = {E}_{i}^{n} - {S}_{i}^{n} \\ Total Corrected lost sales Total Lost Sales = {\sum }_{ }^{ } \frac{{E}_{i}^{n} - {S}_{i}^{n} }{{x}_{i}} \\ where {x}_{i} = {Percentage }^{′} {Missing }^{′} labeled correctly \qquad ( b )$$

In the exemplary embodiment of FIG. 3, after the control unit 210 of the electronic inventory management device 120 estimates whether the product is present or not present on a shelf on the sales floor of the retail sales facility 110 at a selected interval of time on a given day, the control unit 210 outputs a signal including electronic data indicating whether the product 190 is estimated to be present or not present on a shelf on a sales floor of the retail sales facility at the selected interval of time on the given day (step 330). In some embodiments, such an output may be generated on the visual display 260 or via the speaker 280 of the electronic inventory management device 120. In other embodiments, such an output may be transmitted from the electronic inventory management device 120 to the scanning device 130 of the worker. The scanning device 130 may then generate a visual or audible alert to indicate to the worker whether the product 190 is present or not present on the shelf. In some embodiments, such an output may be in the form of an alert including only a list of one or more products 190 estimated not to be present on a shelf 180 on the sales floor 170 of the retail sales facility 110.

FIG. 4 illustrates a system 400 for forecasting on-shelf availability of product 190 at a retail sales facility 110 according to an embodiment. One difference between the system 100 of FIG. 1 and the system 400 of FIG. 4 is that while the system 100 of FIG. 1 includes one electronic inventory management device 120 and one inventory management database 140, the system 400 includes multiple electronic inventory management devices and multiple databases in communication with one another as described in more detail below.

Generally, the system 400 includes two subsystems, an algorithm training sub-system 405 and a product on-shelf availability prediction system 410. While FIG. 4 shows that the algorithm training sub-system 405 and the product on-shelf availability prediction system 410 together utilize multiple computing devices and multiple databases, it will be appreciated that the algorithm training sub-system 405 and the product on-shelf availability prediction system 410 may be incorporated into one electronic computing device, for example, the electronic inventory management device 120 of FIG. 1.

The exemplary algorithm training sub-system 405 shown in FIG. 4 includes a historical data database 415, which may store electronic data including but not limited to historical sales volume of a product 190 at the retail sales facility 110 by time interval, maximum shelf capacity for the product 190 at the retail sales facility 110, and total inventory of products 190 at the retail sales facility 110. The algorithm training sub-system 405 of FIG. 4 includes a training data database 420, which may draw information from the historical data database 415 and physical audits of the shelves 180 for product 190 for one or more interval of time in a given day for training the prediction algorithm

As shown in FIG. 4, an algorithm feature calculation and training application 425 draws data from the training data database 420, processes the data (e.g., by generating and/or analyzing one or more suitable on-shelf prediction factors based at least on data obtained from the historical data database 415 and the training data database 420), and transmits the processed data including the computations generated by the algorithm feature calculation and training application 425 to a classification database 435 for a given instance. An instance is a physically audited observation for the training sub system 405 or prediction for the product on-shelf prediction system 410 for a product 190 on shelf 180 at a given interval of time. The processor of the algorithm feature calculation and training application 425 may be programmed to perform the computation of features (i.e., on-shelf prediction factors), the normalization of the on-shelf prediction factors, the standardization of the on-shelf prediction factors, the algorithm training, and/or classification of the on-shelf prediction factors.

In the embodiment of FIG. 4, the computation of features (i.e., on-shelf prediction factors) data for a given time interval may be calculated by the algorithm feature calculation and training application 425 using historical data obtained from the historical data database 415. The processor of the algorithm feature calculation and training application 425 may also be programmed to perform the feature data normalization using statistical transformations and to perform feature set standardization to account for the effects of scaling difference inherent to the on-shelf inventory factors. In some embodiments, after the estimation of whether the product 190 is present or not present on the shelf 180 is made, a physical audit of the shelves 180 is performed and used to verify the accuracy of the estimation. This data may be stored in training data database 420 In some embodiments, the algorithm may be trained at least in part on one or more physically audited and validated data sets representing only positive instances or instances where the product 190 predicted to be on the shelf 180 was on the shelf 180. Another part of the physically validated data set (test set) passed through the algorithm may consist of both positive and negative instances to test the algorithm accuracy to segregate the instances into correct labels (e.g., 1 for a product 190 present on the shelf 180 and 0 for a product 190 not on the shelf 180).

In some embodiments, the processor of the algorithm feature calculation and training application 425 may be programmed to develop a joint probability distribution function for the on-shelf prediction factors in a training set. Since the data sets are normalized, the processor may be programmed to assume that the data sets represent multi-dimensional normal distribution. The normal probability values of each instance in the training data set can be defined as

[symbol]

=N(x₁, μ₁, σ₁), N(x₂, μ₂, σ₂)N(x₃, μ₃, σ₃). . . N(xₙ, μₙ, σₙ)

where μ and σ are mean and standard deviation of the feature data in the training set.

In some embodiments, the processor of the algorithm feature calculation and training application 425 may be programmed to use a separate data set for testing the effectiveness of the algorithm. For example, processor of the algorithm feature calculation and training application 425 may be programmed to as being effective if it is able to separate the instances into “on shelf” (e.g., value 1) and “not on shelf” (e.g., value 0). The electronic data representing the test set used to test the algorithm may be the historical transaction data obtained from the retail sales facility 110. Since this test set includes both “on shelf” and “not on shelf” instances, to test the algorithm, the processor of the algorithm feature calculation and training application 425 may be programmed to compute the probability values of each of the data points using the joint probability distribution as follows:

[symbol]

ₜₑₛₜ=N(x₁ₜₑₛₜ, μ₁, σ₁), N(x₂ₜₑₛₜ, μ₂, σ₂)N(x₃ₜₑₛₜ, μ₃, σ₃). . . N(xₙₜₑₛₜ, μₙ, σₙ)

The processor of the algorithm feature calculation and training application 425 may be programmed to compute a threshold value of the probability for the distribution function developed using the training set. If this threshold is represented a ω, then for a condition, where [symbol] ₜₑₛₜ<ω, the prediction by the processor of the algorithm feature calculation and training application 425 is 0 (i.e., product 190 not on the shelf 180), and for a condition, where [symbol] ₜₑₛₜ>ω, the prediction by the processor of the algorithm feature calculation and training application 425 is 1 (i.e., product 190 is on the shelf 180).

The exemplary product on-shelf availability prediction sub-system 410 includes a historical data database 440, which, similarly to the historical data database 415, may store historical data including but not limited to historical sales volume of a product 190 at the retail sales facility 110 by time interval, maximum shelf capacity for the product 190 at the retail sales facility 110, and total inventory of products 190 at the retail sales facility 110. The on-shelf availability prediction sub-system 410 of FIG. 4 includes a retail sales facility database 445, which may include real time data including but not limited to transaction data pertaining to sales of products 190 at the retail sales facility 110.

As shown in FIG. 4, the on-shelf availability prediction sub-system 410 further includes a features computation device 450, which may draw data from both the historical data database 440 and the retail sales facility database 445 to generate one or more on-shelf prediction factors that may be factored into a determination of whether a product 190 is present or not present on a shelf 180 at the retail sales facility 110 at a given time. The on-shelf availability prediction sub-system 410 further includes a prediction management device 455 which may include a processor programmed to obtain data (e.g., on-shelf prediction factor(s)) from the features computation device 450 and from the classification database 435 in order to estimate whether a product 190 is present or not present on a shelf 180 at the retail sales facility 110 at a given time. The processor of the features computation device 450 may be programmed to perform the computation of features (i.e., on-shelf prediction factors), the normalization of the on-shelf prediction factors, the standardization of the on-shelf prediction factors, the on-shelf availability estimation/prediction and the on-shelf availability/unavailability alerts.

The electronic data representing the estimation by the processor of the prediction management device 455 as to whether the product 190 is present on the shelf 180 or not may be transmitted to the retail sales facility inventory device 460 (e.g., formatted as a visual or audible alert), which in turn may forward this electronic data to the scanning device 430. The scanning device 430 may in turn generate a visual and/or audible alert to a worker at the retail sales facility indicating whether the product 190 of interest is present on the shelf 180 at a given time interval or not, enabling the worker to take appropriate action based on the alert. Such an action by the working may be picking more units of the product 190 from the bin 150 in the stock room 160 and bringing the picked units of the product 190 to the sales floor 170 for restocking the shelf 180 with the product 190.

As shown in FIG. 4, the prediction management device 455 may be in communication with a scheduling device 470, which may include a processor programmed to generate signals at predetermined intervals in order to initiate the on-shelf estimation sequence at the prediction management device 455. For example, the scheduling device 470 may send such an initiation signal the prediction management device 455 every 15 minute, every 30 minutes, every 1 hour, or at larger intervals. It will be appreciated that the system of FIG. 1 may be configured such that the electronic inventory management device 120 of FIG. 1 is in communication with a scheduling device including a processor programmed to generate signals at predetermined intervals to the electronic inventory management device 120 in order to initiate the on-shelf estimation sequence by the control unit 210 of the electronic inventory management device 120. In some embodiments, the control unit 210 of the electronic inventory management device 120 may be programmed to initiate the on-shelf estimation sequence at predetermined time intervals (every 15 minute, every 30 minutes, every 1 hour) without receiving an initiation signal from a separate electronic device. It will be appreciated that shorter time interval may give better accuracy theoretically than longer time intervals, but this accuracy may be negatively impacted in some instances by poor data approximation and data availability.

The systems and methods described herein analyze one or more on-shelf prediction factors to estimate whether a product is present or not present on a shelf on a sales floor of a retail sales facility at a given time or during a given time interval. Such estimation of whether or not the product is or is not present on the shelf on the sales floor of the retail sales facility advantageously alleviates the need to have workers at the retail sales facility to manually audit the products on the shelves multiple times a day, enabling the workers to perform other tasks that may be more needed.

Those skilled in the art will recognize that a wide variety of other modifications, alterations, and combinations can also be made with respect to the above described embodiments without departing from the scope of the invention, and that such modifications, alterations, and combinations are to be viewed as being within the ambit of the inventive concept.

What is claimed is:

1. A system of forecasting on-shelf availability of at least one product at a retail sales facility, the system comprising:
an electronic inventory management electronic device including a processor-based control unit, the control unit configured to:
obtain electronic data including at least one on-shelf prediction factor associated with the at least one product, the at least one on-shelf prediction factor comprising at least one of: on-shelf probability state of the at least one product at the retail sales facility, conditional probability of sale of the at least one product at the retail sales facility during the selected time interval, root mean square error for cumulative sales of the at least one product at the retail sales facility;
estimate, based on that at least one on-shelf prediction factor, whether the at least one product is present or not present on a shelf on a sales floor of the retail sales facility at a selected interval of time on a given day; and
output, based on the estimation, a signal including electronic data indicating whether the at least one product is present or not present on the shelf on the sales floor of the retail sales facility at the selected interval of time on the given day.

2. The system of claim 1, further comprising at least one electronic database including the at least one on-shelf prediction factor.

3. The system of claim 2, wherein the at least one electronic database further includes at least one of: real-time inventory information associated with the at least one product at the retail sales facility; historical sales information associated with the at least one product at the retail sales facility; and on-shelf estimation training data generated based on a physical audit of the shelf at the retail sales facility containing the at least one product for which an estimation of whether or not present on the shelf is made.

4. The system of claim 1, wherein the at least one on-shelf prediction factor includes at least one of the following additional on-shelf prediction factors associated with the at least one product: probability of sale of the at least one product at the retail sales facility based on at least one interval of time equal to the selected interval of time but on at least one day prior to the given day; a consumer demand for the at least one product at the retail sales facility during a predetermined time interval; average sales of the at least one product at the retail sales facility during the predetermined time interval; average sales of the at least one product at the retail sales facility based on a day of the week; a percentage of sales attributed to sales of the at least one product within a product category associated at the retail sales facility with the at least one product; format of the retail sales facility; travel time for replenishment of the at least one product at the retail sales facility; perpetual inventory of the at least one product at the retail sales facility; total sales of the at least one product at the retail sales facility during at least one time interval preceding the selected interval of time on the given day; time elapsed since last sale of the at least one product at the retail sales facility; available space for the at least one product on the shelf on the sales floor of the retail sales facility; a type of the at least one product; mod effective date; and at least one demographic variable associated with the retail sales facility.

5. The system of claim 1, wherein the control unit is configured to obtain the at least one on-shelf prediction factor associated with a time interval immediately preceding the selected time interval on the given day.

6. The system of claim 1, wherein the control unit is configured to obtain the at least one on-shelf prediction factor associated with a time of day interval identical to the selected time interval on at least one day preceding the given day.

7. The system of claim 1, wherein the control unit is configured to cause the electronic inventory management device to transmit the electronic data indicating whether the at least one product is present or not on the shelf to an electronic device at the retail sales facility.

8. The system of claim 1, wherein the control unit is configured, in response to arriving at an estimation that the at least one product is present on the shelf on the sales floor, to output an indication that the at least one product is present on the shelf; and in response to arriving at an estimation that the at least one product is not present on the shelf on the sales floor, an indication that the at least one product is not present on the shelf

9. The system of claim 1, wherein the control unit is configured to estimate whether the at least one product is present on the shelf or not present on the shelf based on at least two on-shelf prediction factors associated with the at least one product.

10. The system of claim 1, wherein the control unit is configured to modify a value of the at least one on-shelf prediction factor in response to the electronic inventory management device receiving electronic data indicating results of a physical audit of the shelf at the retail sales facility containing the at least one product for which an estimation of whether or not the at least one product is present on the shelf was made by the electronic inventory management device.

11. A method of forecasting on-shelf availability of at least one product at a retail sales facility, the method comprising:
obtaining, by an electronic inventory management device, electronic data including at least one on-shelf prediction factor associated with the at least one product, the at least one on-shelf prediction factor comprising at least one of: an on-shelf probability state of the at least one product at the retail sales facility, a conditional probability of sale of the at least one product at the retail sales facility during the selected time interval, and a root mean square error for cumulative sales of the at least one product at the retail sales facility;
estimating, by a processor-based control unit of the electronic inventory management device and based on the at least one on-shelf prediction factor, whether the at least one product is present or not present on a shelf on a sales floor of the retail sales facility at a selected interval of time on a given day; and
outputting, by the electronic inventory management device and based on the estimating step, a signal including electronic data indicating whether the at least one product is estimated to be present or not present on a shelf on a sales floor of the retail sales facility at a selected interval of time on a given day.

12. The method of claim 11, wherein the obtaining step includes retrieving the electronic data including the at least one on-shelf prediction factor from at least one electronic database.

13. The method of claim 12, wherein the at least one electronic database further includes at least one of: real-time inventory information associated with the at least one product at the retail sales facility; historical sales information associated with the at least one product at the retail sales facility; and on-shelf estimation training data generated based on a physical audit of the shelf at the retail sales facility containing the at least one product for which an estimation of whether or not present on the shelf is made.

14. The method of claim 11, wherein the obtaining step further includes obtaining electronic data including at least one of the following additional on-shelf prediction factors associated with the at least one product: a probability of sale of the at least one product at the retail sales facility based on at least one interval of time equal to the selected interval of time but on at least one day prior to the given day; a consumer demand for the at least one product at the retail sales facility during a predetermined time interval; average sales of the at least one product at the retail sales facility during the predetermined time interval; average sales of the at least one product at the retail sales facility based on a day of the week; a percentage of sales attributed to sales of the at least one product within a product category associated at the retail sales facility with the at least one product; format of the retail sales facility; travel time for replenishment of the at least one product at the retail sales facility; perpetual inventory of the at least one product at the retail sales facility; total sales of the at least one product at the retail sales facility during at least one time interval preceding the selected interval of time on the given day; time elapsed since last sale of the at least one product at the retail sales facility; available space for the at least one product on the shelf on the sales floor of the retail sales facility; a type of the at least one product; mod effective date; and at least one demographic variable associated with the retail sales facility.

15. The method of claim 11, wherein the obtaining step further includes obtaining the at least one on-shelf prediction factor associated with a time interval immediately preceding the selected time interval on the given day.

16. The method of claim 11, wherein the obtaining step further includes obtaining the at least one on-shelf prediction factor associated with a time of day interval identical to the selected time interval on at least one day preceding the given day.

17. The method of claim 11, wherein the outputting step further comprises transmitting the electronic data indicating whether the at least one product is present or not on the shelf to an electronic device at the retail sales facility.

18. The method of claim 11, wherein the outputting step further comprises, when the estimating step supports an estimation that the at least one product is present on the shelf on the sales floor, an indication that the at least one product is present on the shelf; and, when the estimating step supports an estimation that the at least one product is not present on the shelf on the sales floor, an indication that the at least one product is not present on the shelf.

19. The method of claim 11, wherein the estimating step includes estimating, whether the at least one product is present on the shelf or not present on the shelf based on at least two on-shelf prediction factors associated with the at least one product.

20. The method of claim 11, further comprising modifying a value of the at least one on-shelf prediction factor based on obtaining, by the electronic inventory management device, of electronic data indicating results of a physical audit of the shelf at the retail sales facility containing the at least one product for which an estimation of whether or not the at least one product is present on the shelf was made by the electronic inventory management device.
